(19) United States
(12) Patent Application Publication
(10) Pub. No.: US 2004/0177441 A1
(43) Pub. Date: Sep. 16, 2004

(54) Hoist for hoisting or transferring mobility impaired persons

(76) Inventor: Gert S Ronne, Kokkedal (DK)

Correspondence Address: KLEIN, O'NEILL & SINGH, 2 PARK PLAZA, SUITE 510, IRVINE, CA, 92614, US

(21) Appl. No.: 10/476,738

(22) PCT Filed: May 2, 2002
(86) PCT No.: PCT/DK02/00286

(30) Foreign Application Priority Data
May 3, 2001 (DK) PA 2001 00697

(51) Int. Cl. A61G 7/14; A61G 7/10

(52) U.S. Cl. 5/86.1

(57) ABSTRACT

A hoist for hoisting or transferring mobility impaired persons comprises a collapsible support structure (10) and a hoisting device (11-14) mounted thereon and extending upwardly therefrom. The support structure comprises a pair of mutually spaced, elongated foot members (15) arranged on either side of the hoisting device and connecting members, which define at least one parallelogram or nearly parallelogram linkage (18). The parallelogram linkage comprises a pair of parallel or nearly parallel connecting links (19) allowing mutual transverse movement of the foot members (15) between a fully spaced position and a collapsed position, in which the foot members are arranged adjacent to each other. The collapsible hoist may be transported easily from one place of use to another. Thus, it can be transported in the boot of a normal car and can be carried in parts, which do not weigh more than what is generally considered safe for a woman to carry.

### FIELD OF THE INVENTION

The present Invention relates to a hoist for hoisting or transferring mobility impaired people to and from e.g. a bed, a wheelchair and a shower-and commode chair. The hoist according to the Invention is of a type, which is easy to transport in a collapsed condition and even truly portable.

### BACKGROUND OF THE INVENTION

Many elderly and/or Invalid persons have lost their ability of walking or standing up and, consequently, they need assistance In order to transfer themselves or to be transferred from one place to another, e.g. from the bed to the wheelchair. In order to assist such persons a large number of mobile invalid hoists or mobile person hoists are available. In general the concept behind such products is a construction comprising

a mobile chassis with castors, which provides support and stability and

a “hoist” comprising a lifting column or mast—incorporating some kind of power drive or engine—upstanding from the chassis, and a lifting arm pivotally supported by the lifting column or mast. A yoke capable of carrying lifting gear is arranged at the free end of the lifting arm.

The person or patient to be moved is placed in a sling or a similar support unit, which is then hooked onto the yoke. When the engine is activated to move the lifting arm in an upward direction the patient is lifted from e.g. a bed. In order to lower the patient into e.g. a wheelchair the engine is activated so as to move the lifting arm In a downward direction.

Such mobile person hoists are obviously stable during hoisting only when the yoke is always kept within an area defined by the outer perimeter of the chassis. To allow the chassis of such hoist to straddle wide electrical wheelchairs the chassis is usually U-shaped with the lifting column or mast mounted at the bottom of the “U”. Furthermore, as most powered wheelchairs are 60-70 cm wide, the two legs of the U-shaped chassis are most often hinged to the bottom of the U-shape so as to allow for opening the top of the “U” (vide e.g. FIG. 4 In PCT/GB 95/00606). This type of “leg spreading”, which may be either manually or power operated, was chosen in order to keep the overall width of the chassis of the person hoists at a minimum when the hoist Is not in use. Another frequently seen method of adjusting the chassis width Is to have the two legs of the U fixed permanently to the bottom of the U, which bottom part is telescopic, hence allowing for spreading of the legs by changing the width of the bottom of the U-shape.

Consequently, the typical outside width of such a chassis can reduced to approximately 60-70 cm when folded or collapsed, whilst typically allowing for an opening of up to 100 cm at the top of the U-shape when spreading the “legs” to the maximum. With legs, which are normally between 100 and 130 cm long, known chassis for person hoists typically take up much space. Furthermore, the mechanical constructions needed for leg spreading often make the constructions heavy. This results in a number of disadvantages:

Mobile person hoists generally take up much space in the patients' homes when not in use

Mobile person hoists generally weigh between 30-80 kg, making them far too heavy for one person to carry

Mobile person hoists normally result in costly alterations to the patients' homes because they are too wide to pass through standard-width doors.

In short, mobile person hoists are “mobile” In name only; one person can push them about, but one person cannot carry a mobile person hoist from one place of use to another. The known hoists are too heavy to carry without risking back injuries etc., they are too bulky to fit into a normal car or into the boot of a normal car and the size of normal known mobile person hoists require a lot for space both for maneuvering and for storing.

The consequence is that known mobile person hoists are typically delivered to the place of use by truck and several persons are required to carry a hoist into and “Install” It in a home or another place of use. From this time onwards the mobile person hoist will remain at that site, as bringing it to another patient or the patient taking it with him on vacation, family visits, business trips or the like is, If not impossible, then cumbersome. This again means that persons, who are dependent on using a person hoist, have difficulties in living an active life outside of their own four walls. Furthermore, it means that home nurses visiting elderly and/or handicapped persons often find themselves in situations where a person hoist would be the right way of transferring the patient, but no person hoist Is available, as none has been “installed” in the patient's home.

Many manufacturers have attempted to solve the problems of bulkiness and heavy weight by designing mobile person hoists, which can be broken down Into several parts. Normally, mast, engine, lifting arm and yoke can be loosened from the chassis. In some Instances, the legs of the chassis can be loosened from the bottom of the U-shaped chassis. In most cases, the different parts of the hoist are kept together with thumbscrews or other traditional locking methods. However, such constructions are not optimal, as any joint may be connected incorrectly rendering the hoist dangerous to use. Furthermore, it takes a lot of time to assemble and disassemble such constructions. Finally, as the forces created during hoisting are considerable, all joints have to be able to carry the most extreme load possible, leading to substantial increases in weight of the person hoists in question.

### SUMMARY OF THE INVENTION

The present Invention provides a hoist of the above type having the stability and sturdiness of the known mobile person hoists, whilst being portable by a single person.

The hoist according to the invention comprises a collapsible support structure and a hoisting, device mounted thereon and extending upwardly there from, the support structure comprising a pair of mutually spaced, elongated foot members arranged on either side of the hoisting device and being interconnected by connecting members, and the hoist according to the invention is characterised in that the connecting members define at least one parallelogram or nearly parallelogram linkage comprising a pair of parallel or nearly parallel connecting links allowing mutual transverse movement of the foot members between a fully spaced position and a collapsed position, in which the foot members are arranged adjacent to each other.

The hoist according to the invention may be transported easily from one place of use to another. Thus, it can be transported In the boot of a normal car and can be carried In parts, which do not weigh more than what is generally considered safe for a woman to carry.

The hoisting device preferably comprises a mast extending upwardly from the support structure, a lifting arm extending transversely to the mast and being pivotally connected to the upper end of the mast, and power operated means for lifting and lowering the free end of the lifting arm by pivotally moving the lifting arm in relation to the mast.

The weight and bulkiness of the mast, lifting arm, yoke and the electric motor with battery is normally not a problem, because these parts may be made so that they can be folded and/or detached from the supporting structure or chassis. In terms of weight, the forces involved in hoisting a person set a limit to the possible weight reductions. Therefore, reductions In weight and bulkiness in a person hoist should be sought in the supporting structure or chassis. The present invention substantially reduces the bulkiness of the hoist without sacrificing high stability and low weight.

In principle, the support structure may comprise a single parallelogram linkage, only. In the preferred embodiment, however, the connecting members comprise a pair of opposite parallelogram or nearly parallelogram linkages, each connecting a respective one of the foot members with a common base member, which is arranged between the foot members, the hoisting device being mounted on said base member. Furthermore, the support structure Is preferably substantially symmetrical about a symmetry axis extending between the foot members.

In a preferred embodiment a slide member is mounted on the base member so as to be slideable in relation thereto, at least one of the parallel or nearly parallel connecting links of said at least one parallelogram linkage being pivotally interconnected with the slide member by means of a cross link at a position spaced from the point at which said at least one connecting link is pivotally connected to the base member. Then the longitudinal movement of the slide member in relation to the base member controls the pivotal movements of the connecting members in a symmetrical manner.

This arrangement permits each of the foot members to swing relative to the base member, maintaining, however, its orientation parallel or nearly parallel to the longitudinal axis of the base member. The slide member may, for example, be mounted so as to slide along guide rails extending longitudinally along the symmetry line of the base member. By arranging the most heavily loaded pivots or bearings with suitable mutual spacing on the base member and the slide member, by using pivot pins of a suitable vertical length and by using a sturdy base member It Is possible to absorb the load forces optimally and thereby keeping the weight of the total equipment at a minimum.

The hoist according to the Invention preferably comprises locking means for locking said at least one parallelogram linkage in selected pivotal positions in relation to the foot members. In this manner the foot members may be locked In for example an expanded, spaced position and in a collapsed position in which the foot members are positioned close to the base member an on either side thereof. The locking means, which may be of any suitable type, are preferably adapted to lock the slide member in relation to the base member.

The operational length or the stroke of the slide member is preferably such that the pivots at opposite ends of the cross link and the pivot connecting the corresponding connecting link to the base member define a well-shaped triangle over the operational stroke. However, the slide member may preferably also be moved to a position, In which the support structure is collapsed, and a line defined by the pivots of each cross link is substantially coinciding with or defines a small acute angle with a line defined by the pivot points at the opposite ends of the corresponding connecting link. This means that the above-mentioned triangle Is flattened so that the vertices or pivots of the triangle are almost aligned. Thereby the control of the pivotal movements of the connecting links exerted by the longitudinal movement of the slide member Is relaxed to the extent, that the foot members may be folded (independently) together alongside the central base member, permitting a very compact packing condition for transportation and storage of the hoist.

Each foot member is preferably provided with a roller or a castor wheel at either end, permitting the complete support structure to roll on the floor or another support surface.

The invention also provides a collapsible support structure for a hoist as that described above, said support structure comprising a pair of mutually spaced, elongated foot members, which are interconnected by connecting members, and the support structure according to the invention is characterised in that the connecting members define at least one parallelogram or nearly parallelogram linkage allowing mutual transverse movement of the foot members between a fully spaced position and a collapsed position, in which the foot members are arranged closely adjacent to each other.

### BRIEF DESCRIPTION OF THE DRAWINGS

The invention will now be further described with reference to the drawings, wherein

FIGS. 1 and 2 are perspective views of a person hoist according to the invention in different positions of use,

FIG. 3 is the hoist shown in FIGS. 1 and 2 in a collapsed storage position,

FIG. 4 is the collapsed chassis or supporting structure of the hoist shown in FIG. 3, where the mast with the lifting arm has been removed, and

FIG. 5 is a diagrammatic illustration of the interconnected slide member and connecting links.

### DESCRIPTION OF A PREFERRED EMBODIMENT

The drawings Illustrate a hoist of the type used for lifting and moving invalid or disabled persons or patients. The hoist comprises a support structure or chassis 10 having an upright mast or column 11 mounted thereon. One end of a transversely extending lifting arm 12 is pivotally mounted to the upper part of the mast, and a yoke 13 is connected to the other end of the lifting arm 12. Lifting gear, such as a sling, not shown, may be connected to the yoke in a conventional manner. A conventional power unit 14, which may comprise a battery and an electric motor driving a screw drive, extends between and is pivotally connected to the mast 11 and the lifting arm 12, respectively, so that the lifting arm may be moved upwards and downwards by operating the power unit 14.

The Support structure or chassis 10 comprises a pair of substantially parallel rod-like foot members 15 each having castor wheels 16 mounted at opposite ends. A box-like base member 17 is arranged between the foot members 15, and each foot member is connected with the base member 17 by a parallelogram linkage 18. Each parallelogram linkage 18 comprises a pair of connecting links 19, each of which is connected to one of the foot members 15 by pivots or bearings 20 having a pivot pin extending upwardly from the respective foot member. The opposite end of each connecting link 19 Is connected to the base member 17 by pivots or bearings 21.

A slide member 22 is mounted on the base member 17 such that it may slide along guide rails in the longitudinal direction of the rod-like foot members 15. The rearward connecting link 19 in each parallelogram linkage 18 is connected with the slide member 22 by means of a cross link 23. Each cross link is connected to the slide member 22 by means of a pivot or bearing 24 and is connected to the rearward connecting link 19 by means of a pivot or bearing 25, which is spaced from the pivot 21 so that a triangle is defined by the pivots 20 21, 24, and 25. Conventional mechanical locking means, not shown, may be used for locking the slide member 22 in any of a number of predetermined positions In relation to the base member 17, whereby the foot members may be locked in a desired mutual position or spacing. The locking means may, for example, be foot operated, and when the locking means have been released the slide member 22 may also be moved by foot.

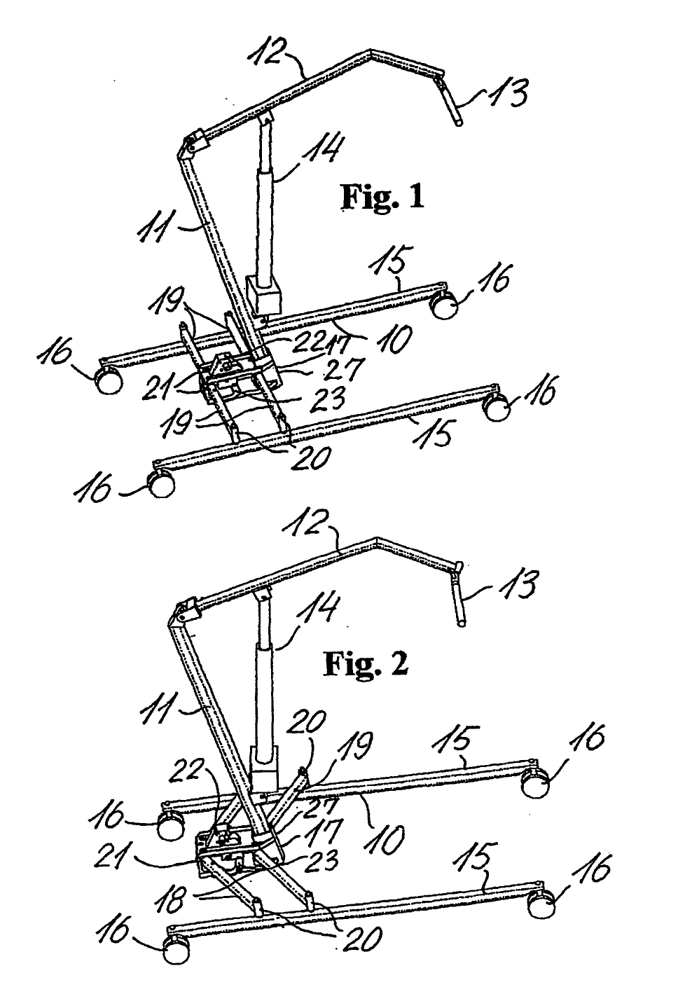

FIGS. 1 and 2 show the hoist in two different positions of use. In FIG. 1 the hoist is shown with maximum spacing of the foot members 15, while the spacing is smaller in FIG. 2.

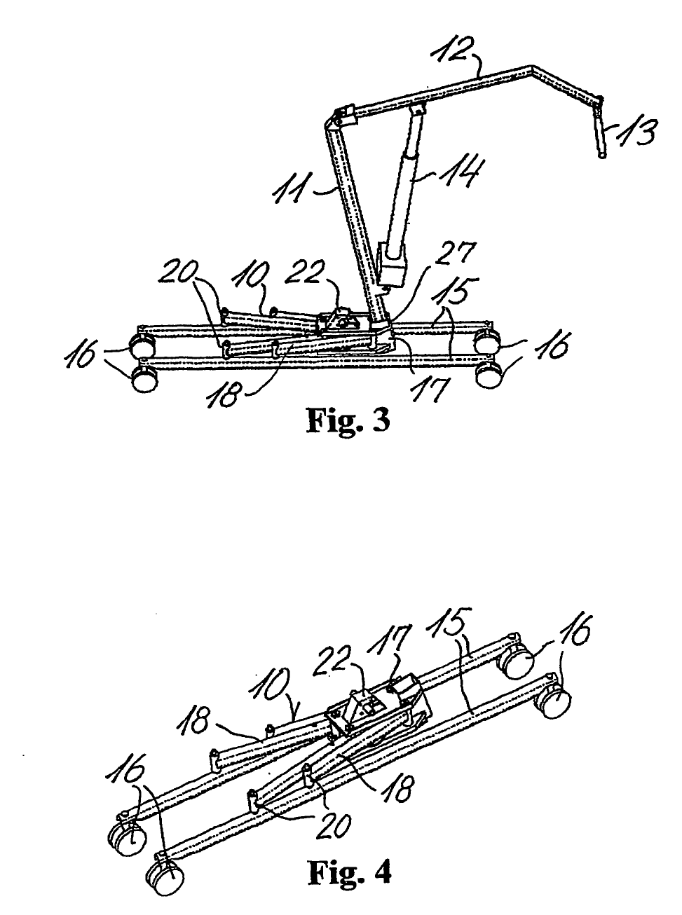

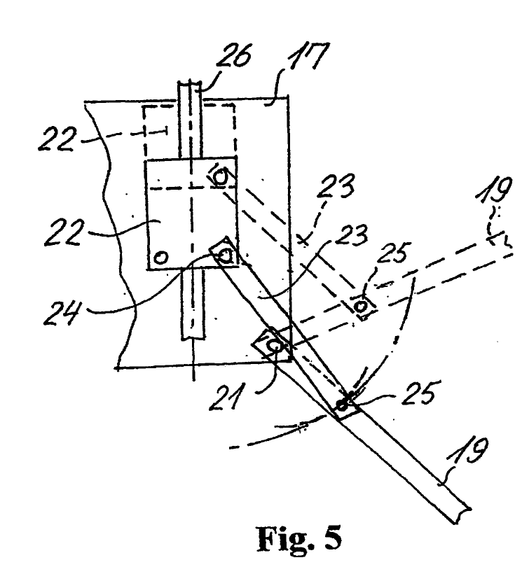

FIG. 5 illustrates how displacement of the slide member 22 in relation to the base member 17 moves the links 19 and 23 and thereby the foot members 15. When the slide member 22 Is moved in the direction indicated by an arrow along a guide rail 26 from the position shown in dotted lines to the position shown in solid lines the links 19 and 23 are moved from a stable position, in which the pivots 21, 24, and 25 define a triangle to a less stable position, in which the said pivots are almost aligned. The latter position is the collapsed position of the hoist shown in FIG. 3.

The base member 17 comprises a socket 27, in which the lower end of the mast or column 11 may be releasable received. Therefore, when the hoist is to be transported or stored, the mast 11 is advantageously removed, so that the chassis 10 may be transported or stored separately in a collapsed condition shown in FIG. 4.

It should be understood that various amendments and changes of the embodiments shown in the drawings could be made with in the scope of the appended claims.

1. A hoist comprising a collapsible support structure (10) and a hoisting device (11-14) mounted thereon and extending upwardly therefrom, the support structure comprising a pair of mutually spaced, elongated foot members (15) arranged on either side of the hoisting device and being interconnected by connecting members (18),
characterised in that the connecting members define at least one parallelogram or nearly parallelogram linkage (18) comprising a pair of parallel or nearly parallel connecting links (19) allowing mutual transverse movement of the foot members (15) between a fully spaced position and a collapsed position, in which the foot members are arranged adjacent to each other.

2. A hoist according to any of the claims 1, wherein the hoisting device comprises a mast (11) extending upwardly from the support structure (10), a lifting arm (12) extending transversely to the mast and being pivotally connected to the upper end of the mast, and power operated means (14) for lifting and lowering the free end of the lifting arm by pivotally moving the lifting arm In relation to the mast.

3. A hoist according to claim 2, wherein the connecting members comprise a pair of opposite parallelogram linkages (18), each connecting a respective one of the foot members with a common base member (17), which Is arranged between the foot members, the hoisting device being mounted on said base member.

4. A hoist according to claim 3, wherein the support structure is substantially symmetrical about a symmetry axis extending between the foot members.

5. A hoist according to any of the claims 1-4, wherein a slide member (22) is mounted on the base member (17) so as to be slideable In relation thereto, at least one of the parallel connecting links (19) of said at least one parallelogram linkage being pivotally Interconnected with the slide member by means of a cross link (23) at a position (25) spaced from the point (21) at which said at least one connecting link (19) is pivotally connected to the base member (17).

6. A hoist according to any of the claims 1-5, further comprising locking means for locking said at least one parallelogram linkage in selected pivotal positions in relation to the foot members.

7. A hoist according to claims 5 and 6, wherein the locking means are adapted to lock the slide member in relation to the base member.

8. A hoist according to any of the claims 5-7, wherein the slide member may be moved to a position, in which the support structure Is collapsed, and a line defined by the pivots (24,25) of each cross link (23) is substantially coinciding with or defines a small acute angle with a line defined by the pivot points (20,21) at the opposite ends of the corresponding connecting link (19).

9. A collapsible support structure for a hoist according to claim 1, said support structure (10) comprising a pair of mutually spaced, elongated foot members (15), which are Interconnected by connecting members (18),
characterised In that the connecting members define at least one parallelogram or nearly parallelogram linkage (18) allowing mutual transverse movement of the foot members (15) between a fully spaced position and a collapsed position, in which the foot members are arranged closely adjacent to each other.

10. A support structure according to claim 9, wherein the connecting members comprise a pair of opposite parallelogram linkages, each connecting a respective one of the foot members with a common base member, which is arranged between the foot members, the base member being adapted to have a hoisting device mounted thereon.

11. A support structure according to claim 9 or 10, said support structure being substantially symmetrical about a symmetry axis extending between the foot members.

12. A support structure according to any of the claims 9-11, wherein a slide member Is mounted on the base member so as to be slideable in relation thereto, at least one of the parallel connecting links of said at least one parallelogram linkage being interconnected with the slide member by means of a cross link at a position spaced from the point at which said at least one connecting link is pivotally connected to the base member.

13. A support structure according to any of the claims 9-12, further comprising locking means for locking said at least one parallelogram linkage in selected pivotal positions In relation to the foot members.

14. A support structure according to claims 12 and 13, wherein the locking means are adapted to lock the slide member in relation to the base member.
